(19) United States
(12) Patent Application Publication
(10) Pub. No.: US 2009/0169940 A1
(43) Pub. Date: Jul. 2, 2009

(54) REACTOR

(75) Inventors: Makoto Ohmori, Nagoya-City (JP); Natsumi Shimogawa, Nagoya-City (JP); Masayuki Shinkai, Ama-Gun (JP); Tsutomu Nanataki, Toyoake-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/331,667

(22) Filed: Dec. 10, 2008

(30) Foreign Application Priority Data
Dec. 26, 2007 (JP) 2007-333560
Nov. 13, 2008 (JP) 2008-290644

(51) Int. Cl. H01M 8/04; H01M 8/10; H01M 2/00

(52) U.S. Cl. 429/26; 429/30; 429/34

(57) ABSTRACT

A fuel cell employs a stack structure in which a plurality of sheet bodies and a plurality of separators are stacked and joined together in alternating layers. Chemical reactions occur in the sheet bodies. The separators separate, from each other, two kinds of gasses (air and fuel gas) which are necessary for the chemical reactions. The plurality of separators consist of high-rigidity separator(s), and ordinary separators, which are lower in rigidity than the high-rigidity separator. This configuration reliably suppresses the occurrence of “separation of a joint region” attributable to “stress concentration caused by increase in the number of the stacked separators.

### BACKGROUND OF THE INVENTION

1. Field of the Invention

The present invention relates to a reactor, such as a solid oxide fuel cell (SOFC), and particularly to a reactor having a (flat-plate) stack structure in which sheet bodies (hereinafter, may be referred to as “single cells”) and separators are stacked in alternating layers.

2. Description of the Related Art

Conventionally, a solid oxide fuel cell having the above-mentioned stack structure has been known (refer to, for example, Japanese Patent Application Laid-Open (kokai) No. 2004-342584). In this case, the sheet body can be a fired body in which a solid electrolyte layer formed from zirconia, a fuel electrode layer, and an air electrode layer are arranged in layers such that the fuel electrode layer is formed on the upper surface of the solid electrolyte layer and such that the air electrode layer is formed on the lower surface of the solid electrolyte layer.

The upper surface of a perimetric portion of each of the separators and the lower surface of a perimetric portion of the sheet body overlying the separator are bonded together by means of a predetermined bonding agent, thereby defining a flow channel (air flow channel) for a gas (air) that contains oxygen. The lower surface of the perimetric portion of the separator and the upper surface of a perimetric portion of the sheet body underlying the separator are bonded together by means of the predetermined bonding agent, thereby defining a flow channel (fuel flow channel) for a fuel gas (hydrogen gas).

According to the above-mentioned configuration, in a state in which the SOFC (specifically, the sheet bodies) is raised in temperature or heated to a working temperature of the SOFC (e.g., 800° C.; hereinafter, merely referred to as the “working temperature”), the fuel gas and air are supplied to the fuel flow channels and the air flow channels, respectively. In this condition, the fuel gas and air come into contact with the upper surfaces and the lower surfaces, respectively, of the sheet bodies, whereby electricity-generating reactions occur in the sheet bodies. Thus, the stack structure can function as a battery. Hereinafter, for convenience of description, the plane direction of each of the stacked sheet bodies (or the stacked separators) is referred to merely as the “plane direction,” and the direction (the direction perpendicular to the plane direction) in which the sheet bodies and the separators are stacked is referred to as the “stacking direction.” In the stack structure, the number of the stacked separators is referred to as the “stack number.”

In recent years, attempts to considerably reduce the size of the SOFC have been made to enhance temperature-rise performance for attaining quick start-up of the SOFC. In order to reduce the size of the SOFC, the thickness of the sheet body and that of the separator must be reduced greatly. That is, by means of reducing the thickness of the sheet body and that of the separator, the thermal capacity of the SOFC can be lowered, and the sheet body can appropriately deform in response to thermal stress. Thus, an SOFC which can cope with quick start-up can be realized. When the thickness of the sheet body is reduced greatly, because of, among other causes, difference in thermal expansion coefficient among three layers used to form the sheet body, the sheet body (particularly its central portion) which has undergone firing is, in an unstacked state, apt to warp in the stacking direction at room temperature.

Therefore, in forming the stack structure of a very small SOFC, a plurality of separators (which, in an unstacked state, are not warped at room temperature) and a plurality of sheet bodies (which, in an unstacked state, are warped at room temperature) are stacked and joined together in alternating layers. In addition to the warping of the sheet bodies at room temperature in an unstacked state, because of the difference between the average thermal expansion coefficient of the sheet body and the thermal expansion coefficient of the separator and other causes, internal stress (thermal stress) may be generated in the interior of the completed stack structure. Studies conducted by the inventors of the present invention have revealed that, when the thus-completed SOFC is allowed to stand at room temperature for a predetermined period of time, separation can occur in some of a plurality of joint regions where the sheet bodies and the separators are joined together. Hereinafter, the separation is referred to as the “separation of a joint region.” Meanwhile, when, in order to restrain the occurrence of the “separation of a joint region,” excess load is applied for joining in assembly of the stack, the sheet body(ies) cracks, resulting in a failure to assemble the stack.

The “separation of a joint region” does not occur when the stack number is “1.” The present inventors infer from this that a large stack number causes local concentration (increase) of the above-mentioned internal stress, thereby causing the occurrence of the “separation of a joint region.” This phenomenon may be referred to as the “stress concentration caused by increase in stack number.” Since the occurrence of the “separation of a joint region” leads to leakage of gas in the interior of the stack structure, the occurrence of the “separation of a joint region” must be restrained.

### SUMMARY OF THE INVENTION

In view of the foregoing, an object of the present invention is to provide a reactor having a stack structure, such as an SOFC, in which, even when the stack number is large, the occurrence of the “separation of a joint region” can be restrained by means of restraining the “stress concentration caused by increase in stack number.”

A reactor according to the present invention comprises a plurality of sheet bodies in which chemical reactions occur, and a plurality of separators differing from the sheet bodies in thermal expansion coefficient. The reactor is configured such that the plurality of sheet bodies and the plurality of separators are stacked in alternating layers. Preferably, in view of reduction in the overall size of the reactor, each of the sheet bodies has a thickness within a range of 20 μm to 500 μm inclusive. Also, preferably, each of the sheet bodies has a uniform thickness. In this case, each of the sheet bodies (particularly, its central portion) may be warped in a stacking direction at room temperature as viewed in an unstacked state or may be warped in the stacking direction at room temperature as viewed in a state incorporated in a stack structure (in a stacked and joined state).

In the reactor, an upper surface of a perimetric portion of each of the separators and a lower surface of a perimetric portion of the sheet body overlying the separator are joined together, thereby defining a flow channel for a first gas to be used in the chemical reactions. Also, a lower surface of the perimetric portion of the separator and an upper surface of a perimetric portion of the sheet body underlying the separator are joined together, thereby defining a flow channel for a second gas to be used in the chemical reactions. That is, the separator has a function of separating two kinds of gases from each other.

In the case where the reactor is an SOFC, each of the sheet bodies is a fired laminate of a solid electrolyte layer, a fuel electrode layer formed on an upper surface of the solid electrolyte layer and having a thermal expansion coefficient greater than that of the solid electrolyte layer, and an air electrode layer formed on a lower surface of the solid electrolyte layer (and having a thermal expansion coefficient substantially equal to that of the solid electrolyte layer). Also, each of the sheet bodies is warped at room temperature such that its central portion is displaced downward in relation to the perimetric portion thereof; the first gas is a gas that contains oxygen; and the second gas is a fuel gas. Each of the sheet bodies is warped such that its central portion is displaced downward (toward the side where the air electrode layer is present) in relation to the perimetric portion thereof, since the fuel electrode layer is greater in thermal expansion coefficient than the air electrode layer.

The reactor according to the present invention is characterized in that a single or a plurality of particular separators among the plurality of separators are higher in rigidity than a single or a plurality of remaining unparticular separators. Herein, the expression “higher in rigidity” means that the lowest rigidity among those of the single or the plurality of particular separators is higher than the highest rigidity among those of the single or the plurality of unparticular separators.

Specifically, the “rigidity” of the separator represents, for example, resistance to displacement (deformation) of a joint region of the perimetric portion of the separator in an unstacked state in a direction along a joint surface (i.e., along a plane direction), the joint region being joined to the sheet body via the joint surface, upon application of an external force (shear force; i.e., force F in FIG. 9, which will be described later) to the joint region in the direction along the joint surface. Hereinafter, the displacement may be referred to as the “displacement caused by shear force.”

The above-mentioned internal stress in the stack structure emerges as the above-mentioned “shear force” which acts along the joint surfaces between the separators and the sheet bodies. The “shear force” increases with internal stress. Additionally, the degree of “stress concentration caused by increase in stack number” is conceived to be apt to increase with the number of the separators having low “rigidity” and arranged continuously in the stacking direction in the stack structure. In other words, when all of the plurality of separators used to form the stack structure are low in “rigidity,” the degree of “stress concentration caused by increase in stack number” is apt to increase. This causes an increase in “shear force” which acts along the joint surfaces subjected to the stress concentration. As a result, the aforementioned “separation of a joint region” is apt to occur.

If all of the plurality of separators used to form the stack structure are rendered high in “rigidity,” the “separation of a joint region” will be reliably prevented. However, in this case, generally, the volume (thickness) of separators must be increased, or a relatively expensive material having a high Young's modulus must be used to form the separators. This raises a problem of an increase in the overall size of the reactor and an accompanying increase in cost.

By contrast, by means of imparting high “rigidity” to only some of the plurality of separators in the stack structure, the above-mentioned increase in size and cost is suppressed. Further, conceivably, by means of reducing the number of the separators having low “rigidity” and arranged continuously in the stacking direction, the degree of “stress concentration caused by increase in stack number” can be lowered.

The above-mentioned configuration of the present invention is conceived on the basis of these findings. Preferably, in the configuration, as will be described later, the “rigidity” of the particular separator is rendered sufficiently high in relation to that of the unparticular separator such that the ratio of the “displacement caused by shear force” of the particular separator to that of the unparticular separator is 70% or less. The term “ratio” means the ratio of the displacement of the particular separator whose rigidity is the lowest among the single or the plurality of particular separators, to the displacement of the unparticular separator whose rigidity is the highest among the single or the plurality of unparticular separators.

In this case, the present inventors have experimentally confirmed that, even when the stack number is large, the occurrence of “separation of a joint region” can be reliably restrained. That is, the above-mentioned configuration can effectively restrain the occurrence of “separation of a joint region” caused by “stress concentration caused by increase in stack number,” while restraining the above-mentioned increase in size and cost.

In order to enhance the “rigidity” of the separator, for example, the thickness of the separator may be increased. In this case, for example, each of the separators has a plane portion, and a frame portion provided along the entire perimeter of the plane portion, being thicker than the plane portion, and serving as the perimetric portion; furthermore, the particular separator is greater in thickness of the plane portion than the unparticular separator, whereby the particular separator is rendered higher in rigidity than the unparticular separator.

In this case, preferably, the plurality of separators arranged in the stacking direction include the single or the plurality of particular separators such that three or more unparticular separators are not continuously arranged in the stacking direction and such that the particular separators are not continuously arranged in the stacking direction.

As will be described later, the present inventors have confirmed that the above-mentioned configuration can effectively restrain the occurrence of “separation of a joint region” without need to excessively increase the number of particular separators, which are thick and included in the plurality of separators arranged in the stack structure. That is, the occurrence of “separation of a joint region” can be restrained, and the following undesirable effects can be restrained: as a result of incorporation of particular separators, which are thick, the overall size, particularly a dimension in the stacking direction (height), of the reactor increases, and the temperature-rise performance (accordingly, the start-up performance) of the reactor deteriorates due to an accompanying increase in the overall thermal capacity of the reactor.

In order to enhance the “rigidity” of the separator, for example, a material having a high Young's modulus may be used to form the separator. In this case, a material used to form the particular separator is higher in Young's modulus than a material used to form the unparticular separator, whereby the particular separator is rendered higher in rigidity than the unparticular separator.

In order to enhance the “rigidity” of the separator, for example, the separator may include another member which is fixedly provided on or in the separator and which has a rigidity higher than that of the separator. In this case, for example, the particular separator may have a heater (which is higher in rigidity than the separator; for example, a ceramic heater) for heating the reactor, whereby the particular separator is rendered higher in rigidity than the unparticular separator. By virtue of this, while the “rigidity” of the particular separator is enhanced, the temperature-rise performance (accordingly, the start-up performance) of the reactor as a whole can be improved.

In this case, the heater may be fixedly embedded in the particular separator or may be fixedly affixed to the upper or lower surface of the particular separator.

The above-mentioned reactor (SOFC) according to the present invention comprises a laminate of a plurality of the sheet bodies and a plurality of the separators, the sheet bodies and the separators being stacked in alternating layers, and a top layer and a bottom layer being the sheet bodies. The reactor (SOFC) is usually configured such that an upper cover member overlies the sheet body which serves as the top layer and such that a lower cover member underlies the sheet body which serves as the bottom layer. Furthermore, an upper surface of a perimetric portion of the lower cover member and a lower surface of a perimetric portion of the sheet body serving as the bottom layer and overlying the lower cover member are joined together, thereby defining a flow channel for the first gas. A lower surface of a perimetric portion of the upper cover member and an upper surface of a perimetric portion of the sheet body serving as the top layer and underlying the upper cover member are joined together, thereby defining a flow channel for the second gas.

The thus-configured reactor (SOFC) according to the present invention is characterized in that at least one of the upper cover member and the lower cover member is higher in rigidity than the plurality of separators. Herein, the expression “higher in rigidity” means that the rigidity of at least one of the upper cover member and the lower cover member is higher than the highest rigidity among those of the plurality of separators.

Specifically, the “rigidity” of at least one of the upper cover member and the lower cover member is rendered sufficiently high in relation to those of the plurality of separators such that the ratio of the “displacement caused by shear force” of the at least one of the upper cover member and the lower cover member to those of the plurality of separators is 70% or less. The term “ratio” means the ratio of the displacement of at least one of the upper cover member and the lower cover member to the displacement of the separator whose rigidity is the highest among the plurality of separators.

The present inventors have experimentally confirmed that, in place of employing the “particular separators” having high rigidity, by means of rendering at least one of the upper cover member and the lower cover member higher in rigidity than the plurality of separators, the occurrence of “separation of a joint region” can be reliably restrained even when the stack number is large. That is, the above-mentioned configuration can also effectively restrain the occurrence of “separation of a joint region” caused by “stress concentration caused by increase in stack number,” while restraining the above-mentioned increase in size and cost.

### BRIEF DESCRIPTION OF THE DRAWINGS

FIG. 1 is a perspective cutaway view of a solid oxide fuel cell according to an embodiment of the present invention;

FIG. 2 is an exploded partial, perspective view of the fuel cell shown in FIG. 1;

FIG. 3 is a sectional view of a separator taken along a plane which contains line 1-1 of FIG. 2 and is in parallel with an x-z plane;

FIG. 4 is a vertical sectional view of a sheet body and a pair of separators in a state of supporting the sheet body therebetween as shown in FIG. 1, the sectional view being taken along a plane which contains line 2-2 of FIG. 2 and is in parallel with a y-z plane;

FIG. 5 is a view for explaining flow of a fuel gas and air in the fuel cell shown in FIG. 1;

FIG. 6 is a schematic view showing a state in which warped sheet bodies and unwarped separators are arranged in alternating layers;

FIG. 7 is a schematic view showing a state after the components shown in FIG. 6 are stacked and joined together;

FIG. 8 is a schematic view showing an example stack structure in which high-rigidity separators, whose plane portions are thick, are inserted as part of a plurality of separators;

FIG. 9 is a view for explaining the force-applied positions and the directions of an external force, which is applied to the separator for determining the rigidity of the separator;

FIG. 10 is a view for explaining the displacement of the separator which is used for determining the rigidity of the separator;

FIG. 11 is a view corresponding to FIG. 8, showing a modified embodiment of the present invention; and

FIG. 12 is a view corresponding to FIG. 8, showing another modified embodiment of the present invention.

### DETAILED DESCRIPTION OF THE PREFERRED EMBODIMENT

A solid oxide fuel cell (reactor) according to an embodiment of the present invention will next be described with reference to the drawings.

### Overall Structure of Fuel Cell:

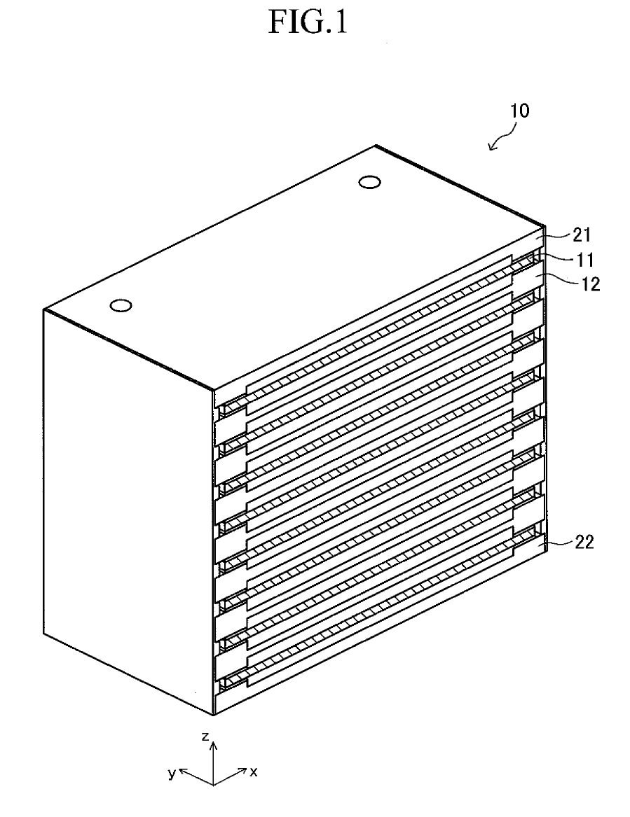

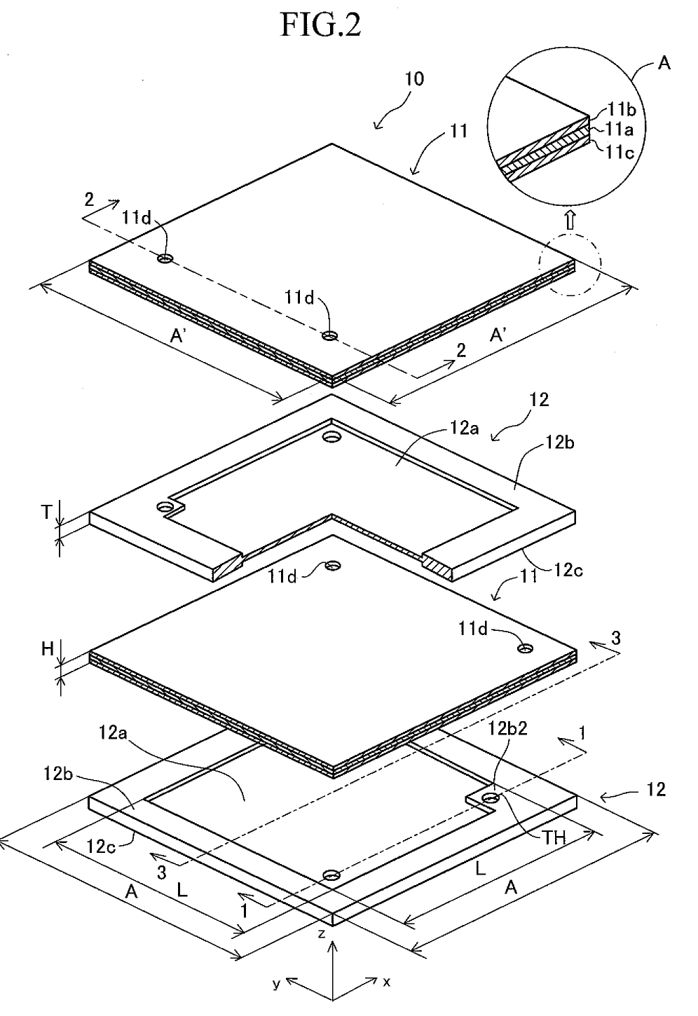

FIG. 1 perspectively shows, in a cutaway fashion, a solid oxide fuel cell (hereinafter, referred to merely as the “fuel cell”) 10, which is a device according to an embodiment of the present invention. FIG. 2 perspectively and partially shows, in an exploded fashion, the fuel cell 10. The fuel cell 10 is configured such that sheet bodies 11 and separators 12 are stacked in alternating layers. That is, the fuel cell 10 has a flat-plate stack structure.

In the flat-plate stack structure, an upper cover member 21 fixedly overlies the top sheet body 11, and a lower cover member 22 fixedly underlies the bottom sheet body 11. The sheet body 11 is also referred to as a “single cell” of the fuel cell 10.

As shown on an enlarged scale within a circle A of FIG. 2, the sheet body 11 is a fired body which has an electrolyte layer (solid electrolyte layer) 11a, a fuel electrode layer 11b formed on the electrolyte layer 11a (on the upper surface of the electrolyte layer 11a), and an air electrode layer 11c formed on a side of the electrolyte layer 11a opposite the fuel electrode layer 11b (on the lower surface of the electrolyte layer 11a). The planar shape of the sheet body 11 is a square having sides (length of one side=A′) extending along mutually orthogonal x- and y-axes. The sheet body 11 has a thickness (H) along a z-axis orthogonal to the x-axis and the y-axis.

In the present embodiment, the electrolyte layer 11a is a dense fired body of YSZ (yttria-stabilized zirconia). The fuel electrode layer 11b is a fired body of Ni-YSZ and a porous electrode layer. The air electrode layer 11c is a fired body of LSM (La(Sr)MnO₃: lanthanum strontium manganite)-YSZ and a porous electrode layer. The electrolyte layer 11a, the fuel electrode layer 11b, and the air electrode layer 11c have room-temperature-to-1,000° C. mean thermal expansion coefficients of about 10.8 ppm/K, 12.5 ppm/K, and 11 (10.8) ppm/K, respectively.

The sheet body 11 has a pair of cell through-holes 11d. Each of the cell through-holes 11d extends through the electrolyte layer 11a, the fuel electrode layer 11b, and the air electrode layer 11c. The paired cell through-holes 11d are formed in the vicinity of one side of the sheet body 11 and in the vicinity of corresponding opposite ends of the side.

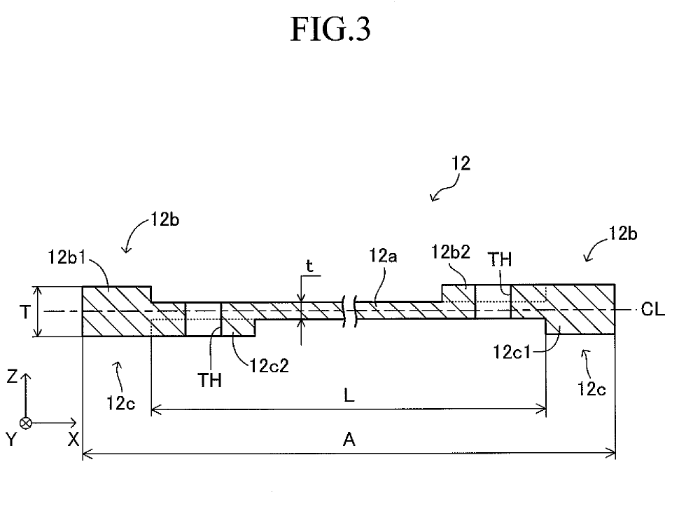

FIG. 3 is a sectional view of the separator 12 taken along a plane which contains line 1-1 of FIG. 2 parallel with the x-axis and is in parallel with the x-z plane.

As shown in FIGS. 2 and 3, the separator 12 includes a plane portion 12a, an upper frame portion 12b, and a lower frame portion 12c. The upper and lower frame portions 12b and 12c collectively correspond to a “frame portion of the separator.” The planar shape of the separator 12 is a square having sides (length of one side=A; A is slightly greater than A′) extending along the mutually orthogonal x- and y-axes. The thickness of the plane portion 12a is t, and the thickness of the “frame portion” is T (>t).

The separator 12 is formed from an Ni-based heat-resistant alloy (e.g., ferritic SUS, INCONEL 600, or HASTELLOY). The separator 12 formed from, for example, SUS430, which is a ferritic SUS, has a room-temperature-to-1,000° C. mean thermal expansion coefficient of about 12.5 ppm/K. Therefore, the thermal expansion coefficient of the separator 12 is greater than the average thermal expansion coefficient of the sheet body 11. Thus, when the temperature of the fuel cell 10 varies, the sheet body 11 and the separator 12 differ in expansion and contraction.

The plane portion 12a is a thin, flat body having a thickness along the z-axis. The planar shape of the plane portion 12a is a square having sides (length of one side=L (<A)) extending along the x-axis and the y-axis.

The upper frame portion 12b is a frame body provided around the plane portion 12a (in a region in the vicinity of the four sides of the plane portion 12a; i.e., an outer perimetric region of the plane portion 12a) in an upwardly projecting condition. The upper frame portion 12b consists of a perimetric frame portion 12b1 and a jutting portion 12b2.

The perimetric frame portion 12b1 is located on a side toward the perimeter of the separator 12. The vertical section of the perimetric frame portion 12b1 (e.g., a section of the perimetric frame portion 12b1 whose longitudinal direction coincides with the direction of the y-axis, taken along a plane parallel with the x-z plane) assumes a rectangular shape (or a square shape).

The jutting portion 12b2 juts toward the center of the separator 12 from the inner perimetric surface of the perimetric frame portion 12b1 at one of four corner portions of the plane portion 12a. The lower surface of the jutting portion 12b2 is integral with the plane portion 12a. The shape of the jutting portion 12b2 as viewed in plane is generally square. The upper surface (plane) of the jutting portion 12b2 is continuous to the upper surface (plane) of the perimetric frame portion 12b1. The jutting portion 12b2 has a through-hole TH formed therein. The through-hole TH also extends through a portion of the plane portion 12a which is located under the jutting portion 12b2.

The lower frame portion 12c is a frame body provided around the plane portion 12a (in a region in the vicinity of the four sides of the plane portion 12a; i.e., an outer perimetric region of the plane portion 12a) in a downwardly projecting condition. The lower frame portion 12c is symmetrical with the upper frame portion 12b with respect to a centerline CL which halves the thickness of the plane portion 12a. Accordingly, the lower frame portion 12c has a perimetric frame portion 12c1 and a jutting portion 12c2 which are identical in shape with the perimetric frame portion 12b1 and the jutting portion 12b2, respectively. However, the jutting portion 12c2 is formed at one of two corner portions among four corner portions of the plane portion 12a, the two corner portions neighboring the corner portion where the jutting portion 12b2 is formed.

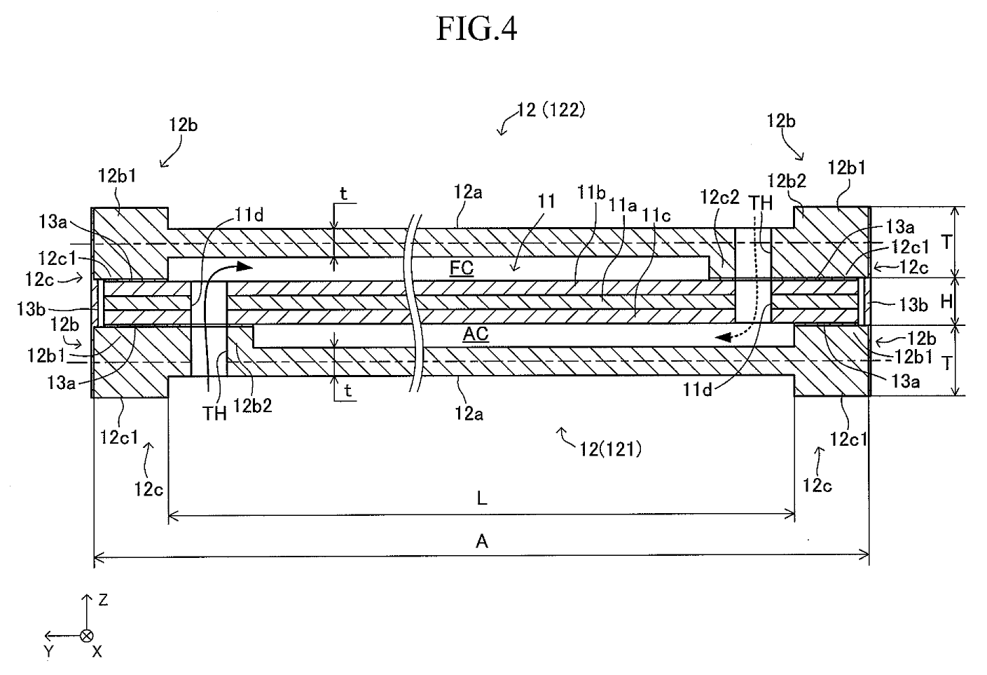

FIG. 4 is a vertical sectional view of the sheet body 11 and a pair of the separators 12 in a state of supporting (holding) the sheet body 11 therebetween, the sectional view being taken along a plane which contains line 2-2 of FIG. 2 parallel with the y-axis and is in parallel with the y-z plane. As mentioned previously, the fuel cell 10 is formed by stacking the sheet bodies 11 and the separators 12 in alternating layers.

For convenience of description, of the paired separators 12, the separator 12 adjacent to the lower side of the sheet body 11 is referred to as a lower separator 121, and the separator 12 adjacent to the upper side of the sheet body 11 is referred to as an upper separator 122. As shown in FIG. 4, the lower separator 121 and the upper separator 122 are coaxially arranged such that the lower frame portion 12c of the upper separator 122 is located above the upper frame portion 12b of the lower separator 121 in a mutually facing manner.

The entire perimetric portion of the sheet body 11 is sandwiched between the upper surface of the upper frame portion 12b (perimetric portion) of the lower separator 121 and the lower surface of the lower frame portion 12c (perimetric portion) of the upper separator 122. At this time, the sheet body 11 is arranged such that the air electrode layer 11c faces the upper surface of the plane portion 12a of the lower separator 121 and such that the fuel electrode layer 11b faces the lower surface of the plane portion 12a of the upper separator 122.

The entire perimetric portion of the sheet body 11 is joined to (sealed against) the upper frame portion 12b of the lower separator 121 and the lower frame portion 12c of the upper separator 122 by means of a seal 13.

The seal 13 has a first seal 13a for joiningly filling (sealing) a space (interface, first joint region) between the upper surface of the perimetric portion of the sheet body 11 and the lower surface of the lower frame portion 12c of the upper separator 122 and for joiningly filling (sealing) a space (interface, first joint region) between the lower surface of the perimetric portion of the sheet body 11 and the upper surface of the upper frame portion 12b of the lower separator 121. The seal 13 also has a second seal 13b, which is separated from the first seal 13a, for joiningly filling (sealing) a space (interface, second joint region) between the lower side end (the lower end of the side surface) of the lower frame portion 12c of the upper separator 122 and the upper side end (the upper end of the side surface) of the upper frame portion 12b of the lower separator 121. The second seal 13b continuously covers the entire side surface of the fuel cell 10 having a stack structure.

The first seal 13a is of amorphous glass having a first softening point lower than the working temperature (e.g., 600° C. to 800° C.) of the fuel cell 10. The first seal 13a exhibits a function of sealing the first joint region. Additionally, when the temperature of the fuel cell 10 (specifically, the temperature of the first seal 13a) is lower than the first softening point, the first seal 13a disables relative movement at the first joint region. When the temperature of the fuel cell 10 (specifically, the temperature of the first seal 13a) is equal to or higher than the first softening point, the first seal 13a is softened, thereby enabling relative movement at the first joint region. This can cancel the aforementioned “shear force” caused by the aforementioned internal stress (thermal stress), thereby restraining the occurrence of cracking in the sheet bodies 11 caused by thermal stress, and a like problem.

The second seal 13b is of ceramic (specifically, a material having crystalline phase, such as crystallized glass or glass-ceramic; amorphous phase and crystalline phase may be mixedly present). The second seal 13b exhibits a function of sealing the above-mentioned second joint region. Additionally, the second seal 13b disables relative movement at the second joint region at all times. By virtue of this, the entire shape (the shape having a stack structure) of the fuel cell 10 can be maintained.

Materials of the same composition can also be used for the first seal 13a, which has a thermal-stress relief function, and the second seal 13b, which has a gas seal function. Use of materials of the same composition can restrain degeneration of the joint regions which could otherwise result from thermal hysteresis in the course of operation of the SOFC.

Specifically, while having the same composition, the materials have different grain sizes of glass so as to differ in the degree of crystallization for imparting different functions to the seals 13a and 13b. For example, the first seal 13a is of a glass material having a large grain size (e.g., about 1 μm), whereas the second seal 13b is of a glass material having a small grain size (e.g., 0.3 μm or less). By virtue of this, at the time of heat treatment (at, for example, 850° C.) for glass bonding in the course of stack assembly, the degree of crystallization can differ therebetween. Specifically, in the first seal 13a having a large grain size, crystallization is not completed, and a semicrystalline state in which an amorphous layer partially remains is maintained. By contrast, in the second seal 13b having a small grain size, crystallization can be completed. As a result, the first seal 13a in a semicrystalline state can have a thermal-stress relief function, and the second seal 13b in which crystallization is completed can have a gas seal function.

One side of the planar shape (square) of the separator 12 has a length A of, in the present embodiment, 5 mm to 200 mm inclusive. One side of the planar shape (square shape) of the plane portion 12a of the separator 12 has a length L of, in the present embodiment, 4 mm to 190 mm inclusive. The “frame portion” of the separator 12 has a thickness T of, in the present embodiment, 200 μm to 1,000 μm inclusive. The thickness t of the plane portion 12a of the separator 12 will be described later.

The thickness H of the sheet body 11 is distributed uniformly throughout the entire sheet body 11 and is, in the present embodiment, 20 μm to 500 g/m inclusive. The thickness H of the sheet body 11 is preferably 20 μm to 300 μm inclusive, more preferably 20 μm to 200 μm inclusive. That is, the sheet body 11 is very thin. The electrolyte layer 11a, the fuel electrode layer 11b, and the air electrode layer 11c have thicknesses of, for example, 1 μm to 50 μm inclusive, 5 μm to 500 μm inclusive, and 5 μm to 200 μm inclusive, respectively.

As mentioned above, in the present embodiment, the fuel electrode layer 11b is the thickest among the components of the sheet body 11. Thus, the fuel electrode layer 11b serves as a support of the sheet body 11. Since the fuel electrode layer 11b contains metal (Ni), the fuel electrode layer 11b has higher flexibility (toughness) than the electrolyte layer 11a and the air electrode layer 11c. Therefore, by means of the fuel electrode layer 11b being the thickest among the components of the sheet body 11, the sheet body 11 can be a flexible structure.

As shown in FIG. 4, the upper surface of the plane portion 12a of the lower separator 121, the inner wall surface of the upper frame portion 12b (the perimetric frame portion 12b1 and the jutting portion 12b2) of the lower separator 121, and the lower surface of the air electrode layer 11c of the sheet body 11 define an air flow channel AC to which a gas that contains oxygen is supplied. As indicated by the broken-line arrow of FIG. 4, the gas that contains oxygen flows into the air flow channel AC through the through-hole TH of the upper separator 122 and the cell through-hole 11d of the sheet body 11.

Also, the lower surface of the plane portion 12a of the upper separator 122, the inner wall surface of the lower frame portion 12c (the perimetric frame portion 12c1 and the jutting portion 12c2) of the upper separator 122, and the upper surface of the fuel electrode layer 11b of the sheet body 11 define a fuel flow channel FC to which a fuel that contains hydrogen is supplied. As indicated by the solid-line arrow of FIG. 4, the fuel flows into the fuel flow channel FC through the through-hole TH of the lower separator 121 and the cell through-hole 11d of the sheet body 11. Although unillustrated in FIG. 4, a current-collecting metal mesh may be confined in each of the air flow channel AC and/or the fuel flow channel FC.

Furthermore, the upper cover member 21 has a lower frame portion (perimetric portion) and a plane portion, which is surrounded by the lower frame portion and is thinner than the lower frame portion. The lower surface of the plane portion of the upper cover member 21, the inner wall surface of the lower frame portion of the upper cover member 21, and the upper surface of the fuel electrode layer 11b of the top sheet body 11 define the fuel flow channel FC to which the fuel that contains hydrogen is supplied.

Similarly, the lower cover member 22 has an upper frame portion (perimetric portion) and a plane portion, which is surrounded by the upper frame portion and is thinner than the upper frame portion. The upper surface of the plane portion of the lower cover member 22, the inner wall surface of the upper frame portion of the lower cover member 22, and the lower surface of the air electrode layer 11c of the bottom sheet body 11 define the air flow channel AC to which the gas that contains oxygen is supplied.

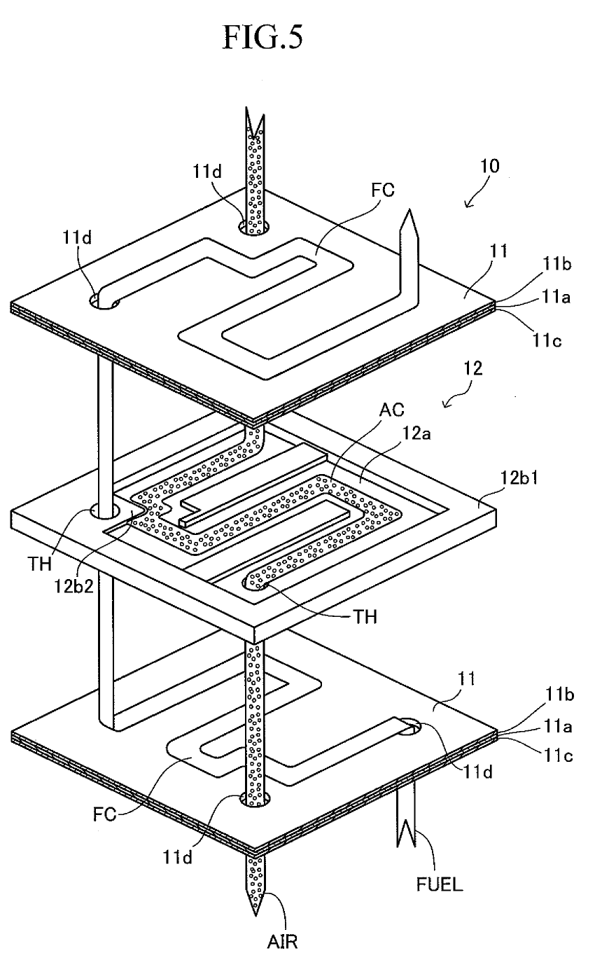

As shown in, for example, FIG. 5, the thus-configured fuel cell 10 is supplied with the fuel into the fuel flow channel FC formed between the fuel electrode layer 11b of the sheet body 11 and the lower surface of the plane portion 12a of the separator 12 and is also supplied with air into the air flow channel AC formed between the air electrode layer 11c of the sheet body 11 and the upper surface of the plane portion 12a of the separator 12, thereby generating electricity according to Chemical Reaction Formulas (1) and (2) shown below.

(1/2).O₂+2^{e-}→O²⁻ (at air electrode layer 11c) (1)

H₂+O²⁻→H₂O+2^{e-} (at fuel electrode layer 11b) (2)

Since the fuel cell (SOFC) 10 utilizes oxygen conductivity of the solid electrolyte layer 11a for generating electricity, the working temperature of the fuel cell 10 is generally 600° C. or higher. Accordingly, the temperature of the fuel cell 10 is raised from room temperature to the working temperature (e.g., 800° C.) by means of an external heating mechanism (e.g., a heating mechanism which uses a resistance heater, or a heating mechanism which utilizes heat generated through combustion of a fuel gas).

### Example of Manufacturing Method:

An example method for manufacturing the fuel cell 10 will next be briefly described. First, the sheet body 11 of, for example, an electrolyte-support-type (the electrolyte layer serves as a support substrate) is formed as follows. A sheet (which is to become the fuel electrode layer 11b) is formed by a printing process on the upper surface of a ceramic sheet (YSZ tape) prepared by a green sheet process; the resultant laminate is fired at 1,400° C. for one hour; a sheet (which is to become the air electrode layer 11c) is formed similarly by a printing process on the lower surface of the resultant fired body; and the resultant laminate is fired at 1,200° C. for one hour.

The sheet body 11 of a fuel-electrode-support-type (the fuel electrode layer serves as a support substrate) is formed as follows. A ceramic sheet (YSZ tape) prepared by a green sheet process is laminated on the lower surface of a sheet (which is to become the fuel electrode layer 11b); the resultant laminate is fired at 1,400° C. for one hour; a sheet (which is to become the air electrode layer 11c) is formed by a printing process on the lower surface of the resultant fired body; and the resultant laminate is fired at 1,200° C. for one hour. In this case, the sheet body 11 may be formed as follows: a ceramic sheet is formed by a printing process on the lower surface of a sheet (which is to become the fuel electrode layer 11b); the resultant laminate is fired at 1,400° C. for one hour; a sheet (which is to become the air electrode layer 11c) is formed by a printing process on the lower surface of the resultant fired body; and the resultant laminate is fired at 1,200° C. for one hour.

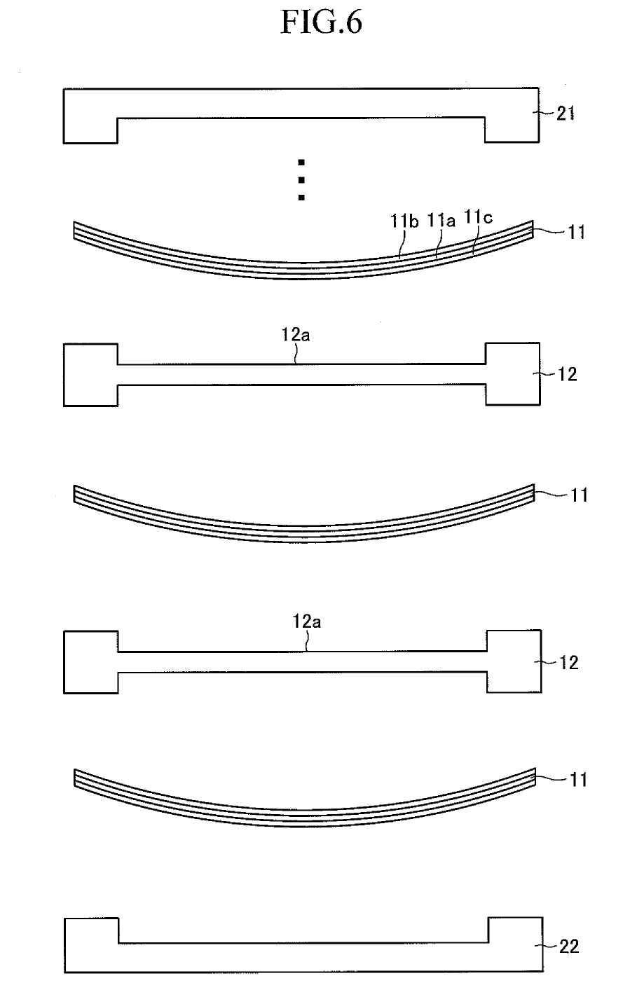

As mentioned above, the sheet body 11 is very thin. Additionally, as mentioned above, three layers that constitute the sheet body 11 differ in thermal expansion coefficient. Accordingly, as shown in FIG. 6, the sheet body 11 (particularly, its central portion) is, in an unstacked state, apt to warp at room temperature such that its central portion is displaced downward (toward the side where the air electrode layer 11c is present) in relation to the perimetric portion thereof. Specifically, in the case where the planar shape of the sheet body 11 is a square whose one side has a length of 10 mm to 100 mm inclusive, the sheet body 11 in an unstacked state has a warp (the height of its central portion above its perimetric portion) of, for example, about 10 μm to 300 μm at room temperature.

The separator 12, the upper cover member 21, and the lower cover member 22 can be formed by, for example, etching or cutting. Since the separator 12 is formed of a homogeneous material, even when the plane portion 12a is very thin, as shown in FIG. 6, the separator 12 is, in an unstacked state, unlikely to warp. Similarly, since the upper and lower cover members 21 and 22 are formed of a homogeneous material, even when their plane portions are very thin, as shown in FIG. 6, the upper and lower cover members 21 and 22 are, in an unstacked state (a state before stacking), unlikely to warp.

Next, a glass material (borosilicate glass) that will form the first seal 13a is applied, by a printing process, to each of the separators 12 at regions of its perimetric portion which come into contact with the respective sheet bodies 11 for holding the sheet bodies 11 (i.e., the glass material is applied to the lower surface of the lower frame portion 12c and to the upper surface of the upper frame portion 12b). Similarly, the glass material (borosilicate glass) that will form the first seal 13a is applied, by a printing process, to the upper and lower cover members 21 and 22 at regions which come into contact with the respective sheet bodies 11 for holding the sheet bodies 11. Then, the separators 12 and the sheet bodies 11 are stacked in alternating layers, thereby yielding a laminate. The upper cover member 21 and the lower cover member 22 are placed on the top and the bottom, respectively, of the laminate. The resultant assembly is heat-treated (at 830° C. for one hour) for integration into a stack structure. The integration is conducted while the sheet bodies 11 are subjected to a tensile force in the plane direction so as to reduce warps of the sheet bodies 11. Subsequently, a material (borosilicate crystallized glass or the like) that will form the second seal 13b is applied to the side wall region of the stack, followed by heat treatment (e.g., at 850° C. for one hour) for reinforcement. The fuel cell 10 thus is completed.

### Insertion of High-Rigidity Separators:

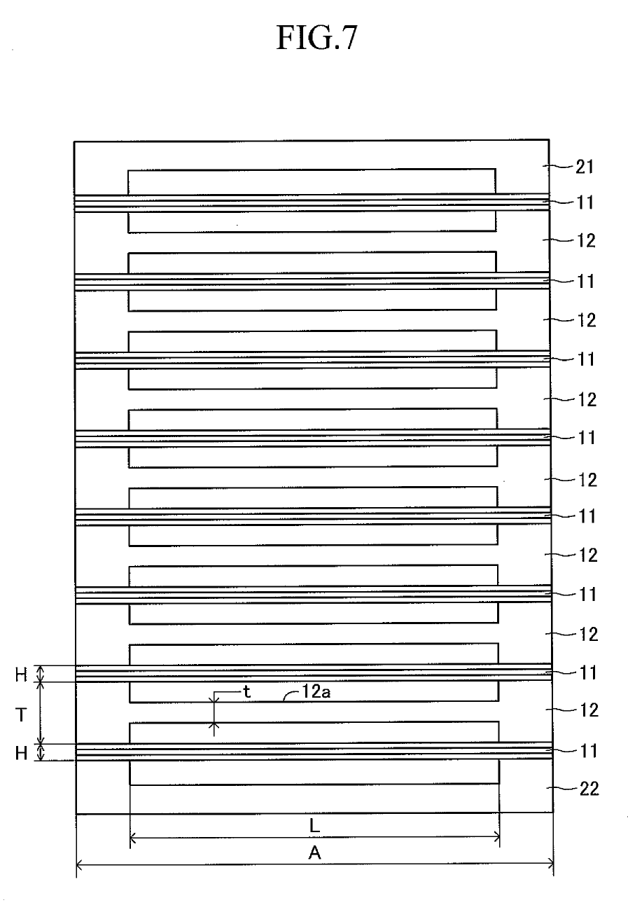

As mentioned above, in order to form a stack structure of the sheet bodies 11 and the separators 12, as shown in FIG. 6, the separators 12, which, in an unstacked state, are not warped at room temperature, and the sheet bodies 11, which, in an unstacked state, are warped, are stacked and joined together in alternating layers. In addition to the warping, in an unstacked state, of the sheet bodies 11 at room temperature, the mean thermal expansion coefficient of the sheet body 11 and the thermal expansion coefficient of the separator 12 differ from each other. Because of this, among other causes, internal stress (thermal stress) could be generated in the completed stack structure shown in FIG. 7. In FIG. 7, the sheet bodies 11 are not warped. However, in actuality, some or all of the sheet bodies 11 may be warped such that a central portion of each sheet body is displaced downward in relation to a perimetric portion thereof. Also, some or all of the separators 12 may be warped in the stacking direction.

According to the findings of studies conducted by the present inventors, in a state in which internal stress is generated as mentioned above and, particularly, in the case where the thickness t of the plane portion 12a of each of the separators 12 is very small (e.g., t=50 μm), when the thus-completed fuel cell 10 is allowed to stand for a predetermined period of time at room temperature, some of a plurality of joint regions between the sheet bodies 11 and the separators 12 can suffer the aforementioned “separation of a joint region.”

According to the findings of studies conducted by the present inventors, the “separation of a joint region” becomes marked when the stack number (i.e., the number of the separators 12 stacked) is large as shown in FIG. 7 (“7” in FIG. 7), and does not occur when the stack number is “1.” The present inventors infer from this that the aforementioned “stress concentration caused by increase in stack number” is responsible for the “separation of a joint region;” i.e., employment of a large stack number causes local concentration (increase) of the above-mentioned internal stress, thereby causing the occurrence of the “separation of a joint region.”

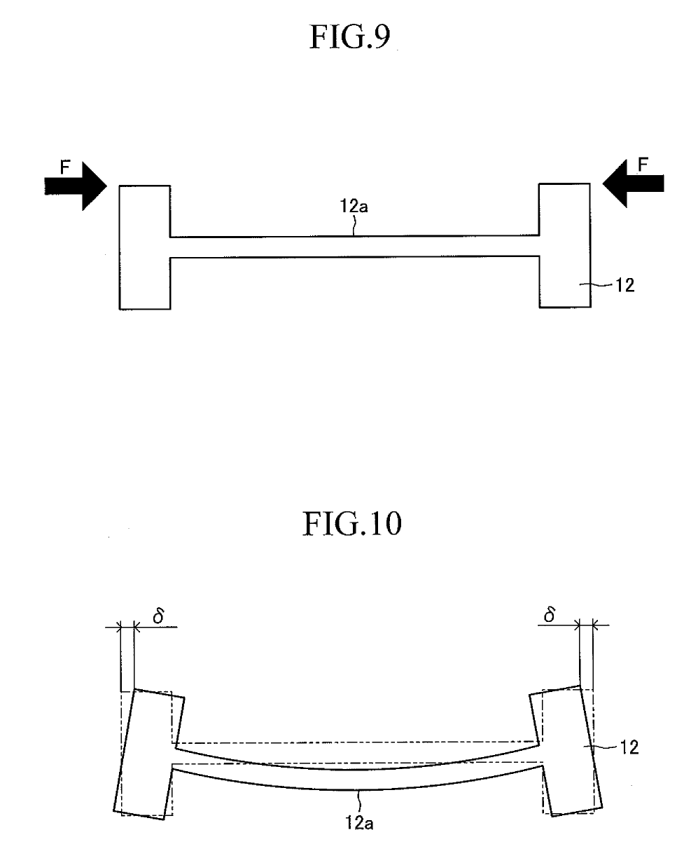

Conceivably, the degree of “stress concentration caused by increase in stack number” is apt to increase with the number of the separators 12 which are small in thickness of the plane portion 12a (e.g., t=50 μm) and thus are low in rigidity and are arranged continuously in the stacking direction in the stack structure. Meanwhile, the internal stress emerges as the above-mentioned “shear force” (force F shown in FIG. 9, which will be described later) which acts along the joint surfaces between the separators 12 and the sheet bodies 11. Therefore, in the case where the thickness of the plane portion 12a of each of the separators 12 used to form the stack structure (stack number=7) shown in FIG. 7 is very small (e.g., t=50 μm), the “shear force” becomes excessively large in the joint surface(s) where the stress concentration has occurred. As a result, the “separation of a joint region” is conceivably apt to arise.

Meanwhile, if all of the separators 12 used to form the stack structure are rendered sufficiently large in thickness of the plane portion 12a (i.e., “rigidity” is increased), the “separation of a joint region” will be reliably prevented. However, this involves the following problems among others. In order to ensure height for the air flow channels 21 and the fuel flow channels 22, the overall height of the stack structure increases. Also, the overall thermal capacity of the stack structure increases, causing deterioration in temperature-rise performance (accordingly, deterioration in start-up performance).

By contrast, by means of imparting a large thickness of the plane portion 12a to only some of the plurality of separators 12 in the stack structure, the above-mentioned increase in height and deterioration in temperature-rise performance are suppressed. Further, conceivably, by means of reducing the number of the separators 12 having low “rigidity” and arranged continuously in the stacking direction, the degree of “stress concentration caused by increase in stack number” can be lowered.

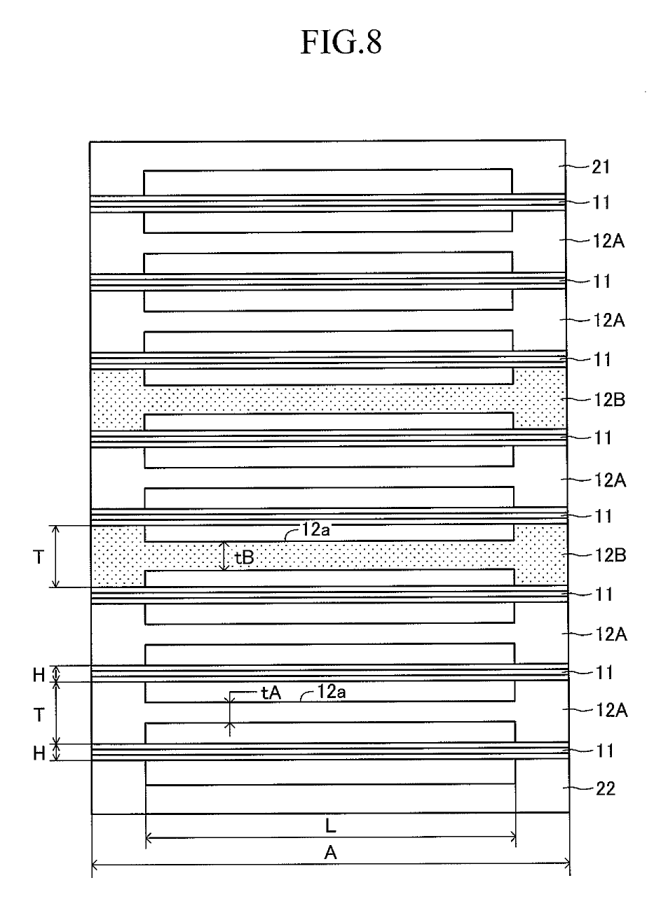

FIG. 8 shows an example stack structure which is designed in view of the foregoing. In the stack structure having a stack number of seven, two of the seven separators 12 are separators (hereinafter, referred to as the “high-rigidity separators 12B;” indicated by fine dotting) which have “high rigidity” and are large in thickness of the plane portion 12a (t=tB), whereas the remaining five separators 12 are separators (hereinafter, referred to as the “ordinary separators 12A”) which have “low rigidity” and are small in thickness of the plane portion 12a (t=tA<tB). The ordinary separators 12A correspond to the aforementioned “unparticular separators,” and the high-rigidity separators 12B correspond to the aforementioned “particular separators.”

The present inventors have experimentally confirmed that, even when the stack number is large as mentioned above, the occurrence of “separation of a joint region” can be reliably restrained by means of inserting the high-rigidity separators 12B as part of the plurality of the separators 12 under certain conditions.

The following description will discuss an appropriate range for the ratio of the thickness of the plane portion 12a (accordingly, the “rigidity” ratio) between the ordinary separator 12A and the high-rigidity separator 12B, and an appropriate arrangement for a single or a plurality of the high-rigidity separators 12B to be inserted into the stack structure.

In the present embodiment, a value indicative of the “rigidity” of the separator 12 is defined as follows. As shown in FIG. 9, a predetermined external force F (i.e., the aforementioned “shear force”) is applied to a joint region of a perimetric portion of the separator 12 in an unstacked state along a joint surface (i.e., along a plane direction). The joint region of the perimetric portion of the separator 12 is joined to the sheet body 11 via the joint surface. In this state, a displacement 6 (see FIG. 10) of the joint region in the direction of the external force F is measured and used as the value indicative of the “rigidity” of the separator 12. The smaller the displacement 6, the higher the “rigidity” of the separator 12.

Studies conducted by the present inventors have revealed the following. Preferably, the ratio of the thickness tB of the plane portion 12a of the high-rigidity separator 12B to the ratio tA of the plane portion 12a of the ordinary separator 12A (tB/tA) is 200% or more. In other words, preferably, the ratio of displacement δB of the high-rigidity separator 12B to displacement δA of the ordinary separator 12A (δB/δA) is 70% or less. Employment of such ratios can effectively restrain occurrence of “separation of a joint region.”

Table 1 shows the results of an experiment which support the above findings. Hereinafter, a stack structure whose “stack number is N” may be referred to as an “N-level stack.” The experiment used 5-level stacks (6 cells each) in which the sheet bodies are fuel-electrode-support-type cells, each composed of a fuel electrode layer (support substrate) having a thickness of 150 μm, an electrolyte layer having a thickness of 3 μm, and an air electrode layer having a thickness of 20 μm. Five separators include a single high-rigidity separator. The high-rigidity separator is inserted in the position of the third layer from the bottom (i.e., in the position of the middle separator among the five separators; thus, the (maximum) number of ordinary separators arranged continuously is 2).

The separators were of SUS430 and were manufactured by an etching process. A flow channel and a fuel channel which were formed on respective opposite sides of each of the separators had a depth of 300 μm. Under these conditions, the stacks were evaluated for occurrence of “separation of a joint region” while the combination of the thickness of each of the ordinary separators (4 pieces) and the thickness of the high-rigidity separator (1 piece) was varied. The “separation of a joint region” was examined by a leak test which was conducted as follows: after assembly of the stacks, a gas was supplied into the stacks to check for seal defect in the interiors and the exteriors of the stacks.

TABLE 1

| Thickness tA of | | | | |
|---|---|---|---|---|
| ordinary separator | Thickness tB of | | | |
| (unparticular | high-rigidity separator | | | |
| separator) | (particular separator) | tB/tA | δB/δA | Results |
| 50 μm | 60 μm | 120% | 95% | Separation of |
| | | | | joint region |
| 50 μm | 80 μm | 160% | 79% | Separation of |
| | | | | joint region |
| 50 μm | 100 μm | 200% | 67% | Good seal |
| 50 μm | 125 μm | 250% | 62% | Good seal |
| 50 μm | 150 μm | 300% | 55% | Good seal |
| 30 μm | 40 μm | 133% | 93% | Separation of |
| | | | | joint region |
| 30 μm | 60 μm | 200% | 70% | Good seal |
| 30 μm | 100 μm | 333% | 58% | Good seal |
| 30 μm | 120 μm | 400% | 46% | Good seal |
| 80 μm | 100 μm | 125% | 93% | Separation of |
| | | | | joint region |
| 80 μm | 160 μm | 200% | 63% | Good seal |
| 80 μm | 200 μm | 250% | 59% | Good seal |
| 80 μm | 250 μm | 313% | 48% | Good seal |

As is understood from Table 1, when the ratio of the thickness tB to the thickness tA (tB/tA) is 200% or more, and the ratio of the displacement δB to the displacement δA (δB/δA) is 70% or less, the occurrence of “separation of a joint region” can be restrained.

Studies conducted by the present inventors have revealed the following. Preferably, a plurality of the separators 12 in a stack structure include a single or a plurality of the high-rigidity separators 12B such that three or more ordinary separators 12A are not continuously arranged in the stacking direction and such that the high-rigidity separators 12B are not continuously arranged in the stacking direction. This configuration can effectively restrain the occurrence of “separation of a joint region” without need to excessively increase the number of the high-rigidity separators 12B, whose plane portions 12a are thick. That is, the occurrence of “separation of a joint region” can be restrained, and the following undesirable effects can be restrained: as a result of incorporation of the high-rigidity separators 12B, which are thick, the overall size, particularly a dimension in the stacking direction (height), of the fuel cell 10 increases, and the temperature-rise performance (accordingly, the start-up performance) of the fuel cell 10 deteriorates due to an accompanying increase in the overall thermal capacity of the fuel cell 10.

Tables 2 and 3 show the results of experiments which support the above findings. The experiment whose results are shown in Table 2 used 4-level stacks(5 cells each). The experiment whose results are shown in Table 3 used 7-level stacks (8 cells each). The thickness of the high-rigidity separator was 100 μm, and the thickness of the ordinary separator was 50 μm. Other conditions were similar to those of the experiment whose results are shown in Table 1.

Under the above-mentioned conditions, the stacks were evaluated for occurrence of “separation of a joint region” while the combination of the number of the inserted high-rigidity separators and the position of each of the inserted high-rigidity separators (accordingly, the (maximum) number of the ordinary separators arranged continuously) was varied. In Tables 2 and 3, “position of inserted high-rigidity separator” indicates what layer separator among all the separators as counted from the bottom-layer separator is the high-rigidity separator(s).

TABLE 2
Results of study on 4-level stacks (5 cells each)

| | | Number of | |
|---|---|---|---|
| | | continuously | |
| Number of inserted | Position of inserted | arranged | |
| high-rigidity | high-rigidity | low-rigidity | |
| separators | separator | separators | Results |
| 0 | — | 4 | Separation |
| | | | of joint region |
| 1 | 2nd layer | 2 | Good seal |
| 2 | 1st layer, 4th layer | 2 | Good seal |

TABLE 3
Results of study on 7-level stacks (8 cells each)

| | | Number of | |
|---|---|---|---|
| | | continuously | |
| Number of inserted | Position of inserted | arranged | |
| high-rigidity | high-rigidity | low-rigidity | |
| separators | separator | separators | Results |
| 1 | 2nd layer | 5 | Separation |
| | | | of joint region |
| 1 | 3rd layer | 4 | Separation |
| | | | of joint region |
| 1 | 4th layer | 3 | Separation |
| | | | of joint region |
| 2 | 3rd layer, 5th layer | 2 | Good seal |
| 3 | 2nd layer, 4th layer, | 1 | Good seal |
| | 6th layer | | |

As is understood from Tables 2 and 3, when a plurality of the separators in a stack structure include a single or a plurality of the high-rigidity separators such that the (maximum) number of the ordinary separators arranged continuously is not 3 or more (i.e., the number is 2 or less) and such that the high-rigidity separators are not continuously arranged, the occurrence of “separation of a joint region” can be restrained without need to excessively increase the number of the high-rigidity separators.

As described above, the solid oxide fuel cell 10 having a flat-plate structure according to the present embodiment employs a stack structure in which a plurality of the sheet bodies 11 and a plurality of the separators 12 are stacked and joined together in alternating layers; chemical reactions occur in the sheet bodies 11; and the separators 12 are adapted to separate, from each other, two kinds of gasses which are necessary for the chemical reactions. The high-rigidity separators 12B are inserted as part of the plurality of separators 12. By virtue of the insertion, even when the stack number is large, the occurrence of “separation of a joint region” caused by “stress concentration caused by increase in stack number” can be reliably restrained.

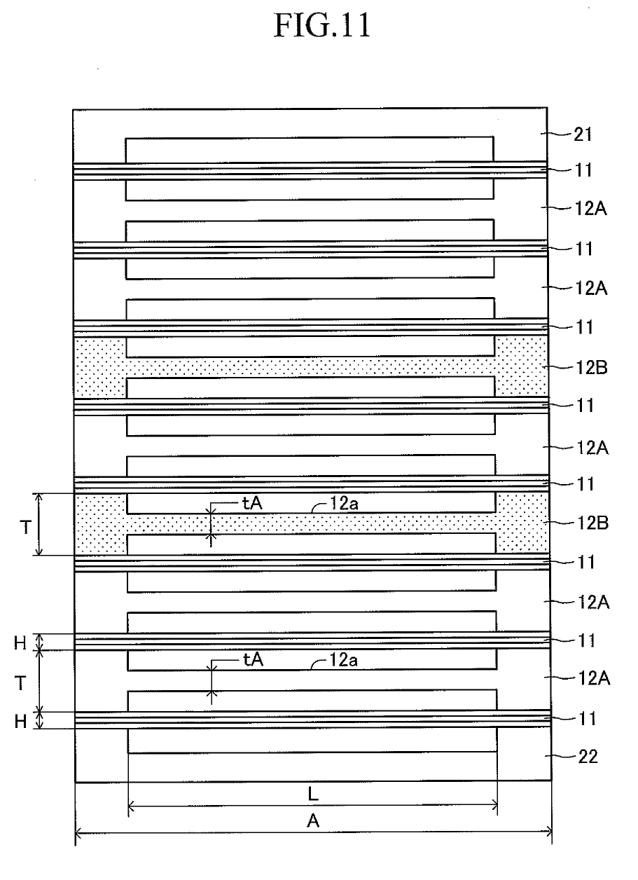

The present invention is not limited to the embodiment described above, but may be modified in various other forms without departing from the scope of the invention. For example, the above-described embodiment uses, as the high-rigidity separator 12B, the separator 12 whose plane portion 12a is thicker than that of the ordinary separator 12A as shown in FIG. 8. However, as shown in FIG. 11, the high-rigidity separator 12B may have the same shape as that of the ordinary separator 12A, but is formed from a material whose Young's modulus is higher than that of a material used to form the ordinary separator 12A.

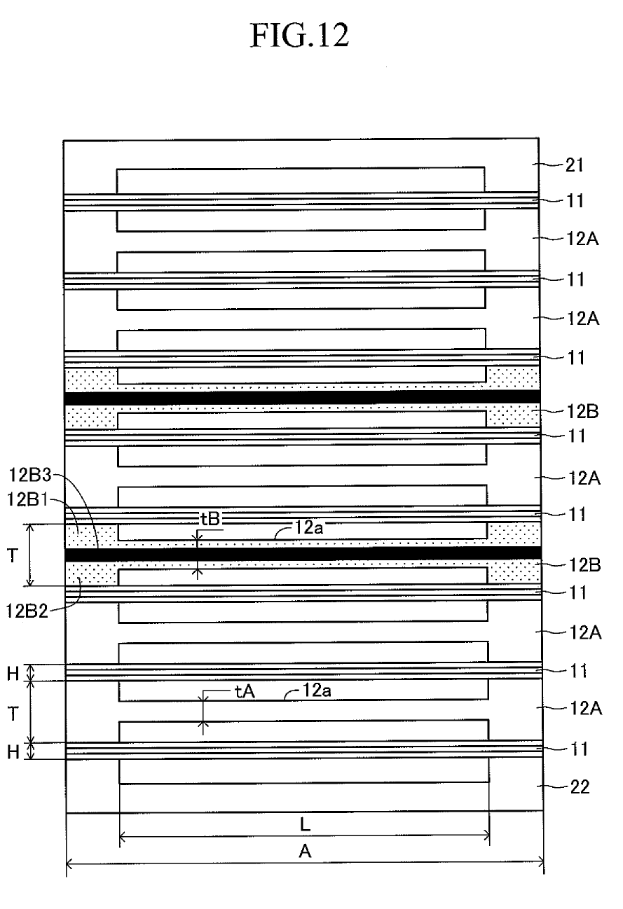

Alternatively, as shown in FIG. 12, the separator 12 which is fixedly provided with a heater (higher in rigidity than the separator 12) for heating the fuel cell 10 may be used as the high-rigidity separator 12B. In this case, for example, a heater 12B3 is sandwiched between an upper half 12B1 and a lower half 12B2 which are obtained by halving the ordinary separator 12A along a horizontal plane, thereby yielding the high-rigidity separator 12B. Examples of a heating mechanism which can be used as the heater 12B3 include a resistance-heating mechanism and a heating mechanism which utilizes heat generated through combustion of a fuel gas.

The separator 12 whose “frame portion” has a width (=(A−L)/2) greater than that of the ordinary separator 12A may be used as the high-rigidity separator 12B.

In the above-described embodiment, the fuel electrode layer 11b can be formed from, for example, platinum, platinum-zirconia cermet, platinum-cerium-oxide cermet, ruthenium, or ruthenium-zirconia cermet.

Also, the air electrode layer 11c can be formed from, for example, lanthanum-containing perovskite-type complex oxide (e.g., lanthanum manganite or lanthanum cobaltite). Lanthanum cobaltite and lanthanum manganite may be doped with strontium, calcium, chromium, cobalt (in the case of lanthanum manganite), iron, nickel, aluminum, or the like. Also, the air electrode layer 11c may be formed from palladium, platinum, ruthenium, platinum-zirconia cermet, palladium-zirconia cermet, ruthenium-zirconia cermet, platinum-cerium-oxide cermet, palladium-cerium-oxide cermet, or ruthenium-cerium-oxide cermet.

In the above-described embodiment, the sheet body 11 and the separator 12 have a planar shape of square. However, the sheet body 11 and the separator 12 may have a planar shape of rectangle, circle, ellipse, etc.

Also, the above embodiment is described while mentioning the solid oxide fuel cell (SOFC) as a reactor. However, the reactor may be a ceramic reactor; for example, an exhaust-gas purification reactor.

According to the above-described embodiment, the high-rigidity separators 12B are inserted as part of a plurality of the separators 12 under certain conditions, whereby, even when the stack number is large, an increase in the overall size of the stack structure is restrained, and the occurrence of “separation of a joint region” is reliably restrained. By contrast, the present inventors have experimentally confirmed that, even when all of the plurality of the separators 12 are the ordinary separators 12A, the same effect is yielded as follows. Under certain conditions, by means of at least one (hereinafter, called the “high-rigidity cover member”) of the upper cover member 21 and the lower cover member 22 having rigidity higher than that of the ordinary separator 12A, even when the stack number is large, an increase in the overall size of the stack structure is restrained, and the occurrence of “separation of a joint region” is reliably restrained. That is, conceivably, by means of the “high-rigidity cover member” having rigidity higher than those of a plurality of the ordinary separators 12A, the degree of “stress concentration caused by increase in stack number” can be reduced.

Specifically, the present inventors have found the following from an experiment equivalent to the experiment whose results are shown in Table 1 described above. Suppose that “δC” represents the displacement 6 (see FIG. 10) of a joint region of a perimetric portion of the high-rigidity cover member in an unstacked state in a direction along a joint surface (i.e., along a plane direction), the high-rigidity cover member being joined to the sheet body 11 at the joint region, upon application of a predetermined external force F (i.e., the aforementioned “shear force” shown in FIG. 9) to the joint region. When the ratio of the displacement δC of the high-rigidity cover member to the displacement δA of the ordinary separator 12A (δC/δA) is 70% or less, the occurrence of “separation of a joint region” can be effectively restrained.

Notably, either one or both of the upper cover member 21 and the lower cover member 22 may correspond to the high-rigidity cover member.

The thickness t of the plane portion 12a of the separator 12 will next be additionally discussed. Preferably, the thickness t is 30 μm to 150 μm inclusive. Generally, as compared with a sheet of a bulk material, sheet metal is more susceptible to oxidation corrosion. Therefore, when the thickness t is less than 30 μm, the following problem arises. When the stack (SOFC) is operated for long hours (e.g., for several hundred hours at 700° C.), the progress of oxidation corrosion of the separator 12 causes gas leakage between the air flow channel AC and the fuel flow channel FC through the plane portion 12a of the separator 12.

Meanwhile, a thickness t in excess of 150 μm is favorable in terms of an increase in rigidity of the separator 12, but raises a problem when the stack is to be quickly started up, since the thermal capacity of the separator 12 (accordingly, the overall thermal capacity of the stack) increases. Specifically, at the time of quick start-up, a temperature variation (difference between maximum temperature and minimum temperature) within the stack increases. This causes an increase in thermal stress which is generated within the stack; as a result, a breakage is apt to occur in the stack.

Particularly, in the case of a small stack (e.g., a stack having a volume of 1 mm³ to 30 mm³ inclusive), since the outer surface area of the stack is small in relation to output, the temperature variation within the stack is apt to increase. For example, even in a state in which electricity is stably generated (at the time of stable electricity generation), a distributive temperature difference of about 20° C. to 50° C. unavoidably arises. Specifically, temperature rises toward a central region along the stacking direction and lowers toward the top and bottom regions along the stacking direction. The distributive temperature difference increases with the thickness of the separator 12; i.e., with the thermal capacity of the separator 12. Additionally, the distributive temperature difference at the time of quick start-up is higher than that at the time of stable electricity generation. Accordingly, in the case of a small stack, if the thermal capacity of the separator 12 (accordingly, the overall thermal capacity of the stack) is large, excessive thermal stress arises within the stack at the time of quick start-up, whereby a breakage is apt to occur in the stack.

What is claimed is:

1. A reactor comprising:
a plurality of sheet bodies in which chemical reactions occur, and
a plurality of separators differing from the sheet bodies in thermal expansion coefficient,
the reactor being configured such that the plurality of sheet bodies and the plurality of separators are stacked in alternating layers,
an upper surface of a perimetric portion of each of the separators and a lower surface of a perimetric portion of the sheet body overlying the separator are joined together, thereby defining a flow channel for a first gas to be used in the chemical reactions, and
a lower surface of the perimetric portion of the separator and an upper surface of a perimetric portion of the sheet body underlying the separator are joined together, thereby defining a flow channel for a second gas to be used in the chemical reactions,
wherein a single or a plurality of particular separators among the plurality of separators are higher in rigidity than a single or a plurality of unparticular separators, which are the remaining separators.

2. A reactor according to claim 1, wherein each of the sheet bodies has a thickness within a range of 20 μm to 500 μm inclusive.

3. A reactor according to claim 2, wherein each of the sheet bodies is warped in a stacking direction at room temperature.

4. A reactor according to claim 3, wherein each of the sheet bodies is a fired laminate of a solid electrolyte layer, a fuel electrode layer formed on an upper surface of the solid electrolyte layer and having a thermal expansion coefficient greater than that of the solid electrolyte layer, and an air electrode layer formed on a lower surface of the solid electrolyte layer;
each of the sheet bodies is warped at room temperature such that its central portion is displaced downward in relation to the perimetric portion thereof;
the first gas is a gas that contains oxygen, and the second gas is a fuel gas; and
the reactor functions as a solid oxide fuel cell.

5. A reactor according to claim 1, wherein the ratio of a displacement of the particular separator in an unstacked state to that of the unparticular separator in an unstacked state is 70% or less, the displacement being a displacement of a joint region of the perimetric portion of the respective separator, which region is jointed to the corresponding sheet body via a contact surface, wherein the displacement is measured in a state in which an eternal force is applied to the joint region in a direction along the joint surface, the measurement being performed along the direction of the external force.

6. A reactor according to claim 5, wherein each of the separators has a plane portion, and a frame portion provided along the entire perimeter of the plane portion, being thicker than the plane portion, and serving as the perimetric portion, and
the particular separator is greater in thickness of the plane portion than the unparticular separator, whereby the particular separator is rendered higher in rigidity than the unparticular separator.

7. A reactor according to claim 6, wherein the plurality of separators arranged in the stacking direction include the single or the plurality of particular separators such that three or more unparticular separators are not continuously arranged in the stacking direction and such that the particular separators are not continuously arranged in the stacking direction.

8. A reactor according to claim 5, wherein a material used to form the particular separator is higher in Young's modulus than a material used to form the unparticular separator, whereby the particular separator is rendered higher in rigidity than the unparticular separator.

9. A separator according to claim 5, wherein a heater for heating the reactor is fixedly provided on or in the particular separator, whereby the particular separator is rendered higher in rigidity than the unparticular separator.

10. A reactor comprising:
a laminate of a plurality of sheet bodies in which chemical reactions occur, and a plurality of separators differing from the sheet bodies in thermal expansion coefficient, the plurality of sheet bodies and the plurality of separators being stacked in alternating layers, and a top layer and a bottom layer being the sheet bodies;
an upper cover member overlying the sheet body which serves as the top layer; and
a lower cover member underlying the sheet body which serves as the bottom layer;
the reactor being configured such that an upper surface of a perimetric portion of each of the separators and a lower surface of a perimetric portion of the sheet body overlying the separator are joined together, thereby defining a flow channel for a first gas to be used in the chemical reactions;
a lower surface of the perimetric portion of the separator and an upper surface of a perimetric portion of the sheet body underlying the separator are joined together, thereby defining a flow channel for a second gas to be used in the chemical reactions;
an upper surface of a perimetric portion of the lower cover member and a lower surface of a perimetric portion of the sheet body serving as the bottom layer and overlying the lower cover member are joined together, thereby defining a flow channel for the first gas; and
a lower surface of a perimetric portion of the upper cover member and an upper surface of a perimetric portion of the sheet body serving as the top layer and underlying the upper cover member are joined together, thereby defining a flow channel for the second gas;
wherein at least one of the upper cover member and the lower cover member is higher in rigidity than the plurality of separators.

11. A reactor according to claim 10, wherein each of the sheet bodies has a thickness within a range of 20 μm to 500 μm inclusive.

12. A reactor according to claim 11, wherein the sheet bodies are warped in a stacking direction at room temperature.

13. A reactor according to claim 12, wherein each of the sheet bodies is a fired laminate of a solid electrolyte layer, a fuel electrode layer formed on an upper surface of the solid electrolyte layer and having a thermal expansion coefficient greater than that of the solid electrolyte layer, and an air electrode layer formed on a lower surface of the solid electrolyte layer;
each of the sheet bodies is warped at room temperature such that its central portion is displaced downward in relation to the perimetric portion thereof;
the first gas is a gas that contains oxygen, and the second gas is a fuel gas; and
the reactor functions as a solid oxide fuel cell.

14. A reactor according to claim 10, wherein the ratio of a displacement of at least one of the upper cover member and the lower cover member in an unstacked state to that of the separator in an unstacked state is 70% or less;
the displacement of the least one of the upper cover member and the lower cover member is a displacement of a joint region of the perimetric portion of the least one of the upper cover member and the lower cover member, which region is jointed to the corresponding sheet body via a contact surface, wherein the displacement is measured in a state in which an eternal force is applied to the joint region of the perimetric portion of the least one of the upper cover member and the lower cover member in a direction along the joint surface, the measurement being performed along the direction of the external force; and
the displacement of the separator is a displacement of a joint region of the perimetric portion of the separator, which region is jointed to the corresponding sheet body via a contact surface, wherein the displacement is measured in a state in which an eternal force is applied to the joint region of the perimetric portion of the separator in a direction along the joint surface, the measurement being performed along the direction of the external force.
